(19) United States
(12) Patent Application Publication
(10) Pub. No.: US 2008/0151703 A1
(43) Pub. Date: Jun. 26, 2008

(54) APPARATUS FOR PROCESSING A DEFECT IN AN OPTICAL DISC APPARATUS

(76) Inventors: Je-kook Kim, Yongin-si (KR); Jun-ho Huh, Yongin-si (KR); Sang-hoon Moon, Suwon-si (KR)

Correspondence Address: F. CHAU & ASSOCIATES, LLC, 130 WOODBURY ROAD, WOODBURY, NY, 11797, US

(21) Appl. No.: 11/772,952

(22) Filed: Jul. 3, 2007

(30) Foreign Application Priority Data
Dec. 20, 2006 (KR) 10-2006-0130838

(51) Int. Cl. G11B 20/18

(52) U.S. Cl. 369/30.11

(57) ABSTRACT

An apparatus for processing a defect includes a defect detection unit and a main filter. The defect detection unit detects a presence of a defect in a disc, and when the defect is detected, outputs a reset signal to the main filter. The main filter receives a focus error signal or a tracking error signal, which are digital signals, and outputs a focus regulation signal or a tracking regulation signal to regulate a focus or a tracking location of the disc by filtering the focus error signal or the tracking error signal. The reset signal is applied to the main filter and resets the signal values of a high-frequency component existing in the main filter to 0. Using the apparatus, a peaking phenomenon of the focus regulation signal or the tracking regulation signal can be removed and, accordingly, an accurate servo filter characteristic can be obtained.

### CROSS-REFERENCE TO RELATED PATENT APPLICATION

This application claims the benefit of Korean Patent Application No. 10-2006-0130838, filed on Dec. 20, 2006, in the Korean Intellectual Property Office, the disclosure of which is incorporated herein in its entirety by reference.

### BACKGROUND OF THE INVENTION

1. Technical Field of the Invention

The present disclosure relates to an apparatus for processing a defect in an optical disc apparatus and, more particularly, to an apparatus for processing a defect that generates a tracking regulation signal or a focus regulation signal when a defect is present on the surface of a disc installed in an optical disc apparatus.

2. Discussion of Related Art

In an optical disc system, data is written and read along a groove formed on a surface of a disc, that is, along a disc track on the surface of the disc. A head reads the rotating disc and amplifies a radio frequency (RF) signal and then generates a tracking error (TE) signal using the amplified RF signal. Then, a tracking regulation (TRO) signal is generated using the generated TE signal to regulate and compensate for any tracking error.

Also, while reading the data by irradiating light on the rotating disc, focusing of the irradiated light on the disc should be regulated perpendicularly to the disc surface. Hence, a focus error (FE) signal includes information about whether the focusing is correctly adjusted or not. Then, a focus regulation (FRO) signal is generated using the FE signal to regulate and compensate for the focusing of the irradiated light on the disc.

Accordingly, an apparatus for processing a defect, which receives the FE signal or the TE signal, and generates the FRO signal and the TRO signal in order to track the desired disk track and to adjust the focusing of the irradiated light on the disc is required.

FIG. 1A illustrates a conventional apparatus 100 for processing a defect in an optical disc apparatus.

Referring to FIG. 1A, the conventional apparatus 100 for processing a defect in an optical disc apparatus includes a DC hold filter 101, a defect detection unit 103, a switching unit 110, a focus/tracking main filter 120, and a digital to analog converter (DAC) 105.

When a defect is present on the surface of the disc, the defect detection unit 103 detects the defect and outputs a defect control signal D_CON. In this example, the defect indicates the presence of a fingerprint adhered on the surface of the disc, a contaminant adhered on the surface of the disc, a groove on the surface of the disc, a scratch on the surface of the disc, or the like.

If the defect exists on the surface of the disc, the reading of data may fail as performed by a read signal (RF signal) generated by an optical pickup (not shown) while reproducing the disc (reading the data), and the controlling capability of a servo controlling the tracking, the focus, and the like, may deteriorate. Accordingly, when the defect is present on the surface of the disc, the defect detection unit 103 immediately outputs the defect control signal D_CON in order to process the defect of the conventional apparatus 100.

When the defect control signal D_CON is applied to the switching unit 110 after the defect control signal D_CON is activated to logic high, the DC hold filter 101 outputs a uniform value so as to output the FRO signal or the TRO signal as uniform values. Hence, a fixed DC value is held and then outputted from the DC hold filter 101 to the focus/tracking main filter 120. Here, the fixed DC value is a signal having a low frequency.

When the defect control signal D_CON is applied to the switching unit 110 as logic high, the switching unit 110 transmits an output signal Out_DChold of the DC hold filter 101 to the focus/tracking main filter 120 in response to the applied defect control signal D_CON. Before the defect is present, the switching unit 110 is connected to an L terminal so as to input the FE signal or the TE signal to the focus/tracking main filter 120.

The focus/tracking main filter 120 receives and filters the FE signal or the TE signal in order to output the FRO signal or the TRO signal, which, regulate the focus or tracking position of the head on the disc.

The focus/tracking main filter 120 includes a high-frequency gain filter 122 and a low-frequency gain filter 124.

The FE signal and the TE signal are digital signals converted from analog signals. Accordingly, an analog to digital converter (ADC) (not shown) is installed in front of the input ports of the FE signal and the TE signal.

The high-frequency gain filter 122 of the focus/tracking main filter 120 receives the FE signal and the TE signal and outputs the FE signal and the TE signal after filtering the high-frequency components of the FE signal and the TE signal. In this case, the high-frequency components of the FE signal and the TE signal are at 500 Hz or more, that is, a signal filtered from a frequency band that is required to be amplified by a user. The high-frequency gain filter 122 is not a high-pass filter (HPF), however, the high-frequency gain filter 122 has the characteristics of a bandpass filter (BPF), in other words, not all signals in a certain frequency or more are filtered, however, signals in a frequency band, which a user desires to filter, are filtered.

The high-frequency gain filter 122 filters a signal in a relatively high-frequency band f_h. In this case, the relatively high-frequency band f_h that is to be filtered can be set differently according to an apparatus used or a user and, thus, the relatively high-frequency band f_h is not limited. The high-frequency components filtered and outputted from the high-frequency gain filter 122 are an AC component signal.

The low-frequency gain filter 124 receives the FE signal or the TE signal and outputs the FE signal or the TE signal after filtering the low-frequency components of the FE signal or the TE signal. In this case, the low-frequency components of the FE signal or the TE signal are a signal at 100 Hz or lower, that is, a signal filtered from a frequency band that is required to be amplified by a user.

The low-frequency gain filter 124 has characteristics of a low-pass filter (LPF). Accordingly, a signal in a relatively low frequency band f_1 or below is filtered and then outputted from the low-frequency gain filter 124. In this case, the low-frequency band f_1 that is to be filtered can be set differently according to an apparatus used or a user and, thus, the low-frequency band f_1 is not limited. The low-frequency components passed by the low-frequency gain filter 124 are a DC component signal.

An adder 126 adds an output signal O_HF of the high-frequency gain filter 122 and an output signal O_LF of the low-frequency gain filter 124 and then outputs the result. Accordingly, an output signal of the adder 126 is a signal resulting from the addition of the DC component signal in the low-frequency hand f_1 and the AC component signal in the high-frequency band f_h.

The DAC 105 outputs each FRO signal and TRO signal by converting the signal outputted from the adder 126 to an analog signal through the digital to analog converter (DAC) 105.

Hereinafter, the operations of the conventional apparatus 100 will be described with reference to FIGS. 1B, 2A, and 2B.

FIG. 1B is a diagram illustrating the DC hold filter 101 used in the conventional apparatus 100 illustrated in FIG. 1A.

Referring to FIG. 1B, the DC hold filter 101 includes a plurality of amplifiers 151, 153, and 155, an adder 157, and a filtering device 159.

The DC hold filter 101 receives the FE signal or the TE signal and outputs the received FE signal or the TE signal after filtering very low frequency band components (the DC component) of the FE signal or the TE signal. Since the DC hold filter 101 filters the DC components of the FE signal or the TE signal, roughly uniform fixed values are continuously outputted from the DC hold filter 101. Conventionally, the output signal Out_DChold of the DC hold filter 101 may be a fixed DC value of 0.

Hence, K20, K21, and K22 are the respective amplifier gains of the amplifiers 151, 153, and 155. The adder 157 adds an output signal of the amplifier 151 and an output signal of the amplifier 153 and then outputs a result. The filtering device 159 performs a filtering process on a certain frequency band and corresponds to a capacitor of an analog filter.

The overall operation principles of the DC hold filter 101 are described in U.S. Pat. Nos. 6,693,521 and 5,682,307. Also, the constitutions and operations of the DC hold filter 101 are well known to one of ordinary skill in the related art and, thus, detailed descriptions thereof will be omitted.

FIG. 2A is a diagram illustrating the characteristics of each filter of the conventional apparatus 100 of FIG. 1A that is used for processing a defect.

The first graph 210 of FIG. 2A illustrates a frequency response curve of the high-frequency gain filter 122. In the first graph 210, signals in a certain relatively high-frequency band between the frequencies f_h1 and f_h2 and having a frequency f_h as a center are filtered. The high-frequency gain filter 122 outputs signals having frequencies between the frequencies f_h1 and f_h2 of the relatively high frequency band and filters signals below frequency f_h1 and above frequency f_h2.

The second graph 220 of FIG. 2A illustrates a frequency response curve of the low-frequency gain filter 124. In the second graph 220, signals above a relatively low frequency band of a frequency f_1 are filtered. The low-frequency gain filter 124 outputs signals having a frequency less than or equal to the frequency f_1 and filters signals having frequencies above f_1.

The third graph 230 illustrates a signal output from the adder 126. In the third graph 230, the signal in which signals illustrated in the first and second graphs 210 and 220 are added is outputted. The signal outputted from the adder 126 has both high-frequency components and low-frequency components.

The fourth graph 240 illustrates the FRO signal and the TRO signal, which have passed through the adder 126 and have already been converted into analog signals through the DAC 105. In a signal output from the adder 126, a high-frequency component signal 242 and a low-frequency component signal 244 coexist.

FIG. 2B illustrates signals outputted from the apparatus 100 of FIG. 1A used for processing a defect.

Referring to FIG. 2B, a disc is read for a track section from a to b having a defect, for example, a finger print, a contamination, or a scratch.

An RF signal is generated by an optical pickup from a rotating disc. The generated RF signal having a uniform frequency indicates that the disc does not have a defect, and the RF signal is regularly generated and outputted. When a defect is present on the disc, the RF signal cannot be generated and there is a gap during a section 252 of the RF signal indicating the presence of a defect.

The defect detection unit 103 detects that the track section from a to b (or a time when reading the track) has the defect, and outputs the defect control signal D_CON activated as logic high during the track section from a to b having the defect. A signal DEFECT is a signal indicating the presence of the defect. Accordingly, the signal DEFECT has the same signal form as the defect control signal D_CON.

When the defect is present on the disc, a switch of the switching unit 110 is switched to an H terminal and an output terminal of the DC hold filter 101 is connected to an input terminal of the focus/tracking main filter 120, whose input signal is called FE1/TE1 and, thus, the signal FE1/TE1 during the track section from a to b having the defect is outputted from the DC hold filter 101 as a fixed value 254. Accordingly, discontinuous points 256 and 258 occur in the signal when the defect occurs and respectively end at discontinuous occurrence points a and b.

The focus/tracking main filter 120 is formed as a LPF and a BPF. Based on the characteristics of a filter in terms of when the LPF and the BPF receive the discontinuous signal from the DC hold filter 101, a peaking phenomenon occurs. Accordingly as illustrated in FIG. 2B, the FRO signal and the TRO signal reach peaks at the discontinuous occurrence points a and b. For reference, the DC hold filter 101 outputs a signal having a DC component having a uniform value with a very low frequency component.

As described above, the conventional apparatus 100 for processing a defect prevents a wrongful tracking and regulates a focus by connecting the output of the DC hold filter 101 to an input terminal of the focus/tracking filter 120 when the defect is present. The discontinuous points a and b that occur in the signal inputted to the focus/tracking main filter 120, however, cannot be removed. Accordingly, the peaking phenomenon of the FRO signal or the TRO signal at the discontinuous points a and b cannot be prevented. When the peaking occurs, the tracking or the focusing cannot be correctly regulated. In other words, the tracking may be inaccurately performed and the focus of the light beam cannot be accurately adjusted.

### SUMMARY OF THE INVENTION

Exemplary embodiments of the present invention provide an apparatus for processing a defect, the apparatus has a simple constitution, is able to operate stably by removing a peaking phenomenon, and can accurately regulate tracking or focusing.

According to an exemplary embodiment of the present invention, there is provided an apparatus for processing a defect, the apparatus including: a defect detection unit that detects a defect in a disc, and when the defect occurs, outputs a reset signal to a main filter; and the main filter that receives a focus error signal or a tracking error signal, which are digital signals, and outputs a focus regulation signal or a tracking regulation signal to regulate a focus or a tracking location by filtering the focus error signal or the tracking error signal, wherein the reset signal resets signal values of a high-frequency component existing in the main filter to 0.

The main filter may reset the signal values of the high-frequency component to 0 when the reset signal is applied thereto, and output the focus regulation signal or the tracking regulation signal after removing the high-frequency component of the focus error signal or the tracking error signal.

The main filter may include: a high-frequency gain filter that filters the focus error signal or the tracking error signal to have a high-frequency gain and then outputs the filtered focus error signal or the tracking error signal; a low-frequency gain filter that filters the focus error signal or the tracking error signal to have a low-frequency gain and then outputs the filtered focus error signal or the tracking error signal; and an adder that outputs the focus regulation signal or the tracking regulation signal by adding an output of the high-frequency gain filter and an output of the low-frequency gain filter.

The apparatus may further include a digital to analog converter (DAC) that receives the focus regulation signal or the tracking regulation signal from the main filter and then outputs the focus regulation signal or the tracking regulation signal after converting the focus regulation signal or the tracking regulation signal to an analog signal.

### BRIEF DESCRIPTION OF THE DRAWINGS

Exemplary embodiments of the present invention will be understood in more detail from the following descriptions taken in conjunction with the attached drawings, in which:

FIG. 1A is a drawing illustrating a conventional apparatus for processing a defect in an optical disc apparatus;

FIG. 1B is a diagram illustrating the DC hold filter installed in the conventional apparatus illustrated in FIG. 1A;

FIG. 2A is a diagram illustrating characteristics of each filter of the conventional apparatus, as illustrated in FIG. 1A, for processing a defect;

FIG. 2B illustrates signals outputted from the conventional apparatus, illustrated in FIG. 1A, for processing a defect;

FIG. 3 is a diagram illustrating an apparatus for processing a defect, the apparatus included in an optical disc apparatus according to an exemplary embodiment of the present invention;

FIG. 4A is a diagram illustrating a high-frequency gain filter of the apparatus illustrated in FIG. 3 in detail, according to an exemplary embodiment of the present invention;

FIG. 4B is a diagram illustrating a low-frequency gain filter of the apparatus illustrated in FIG. 3 in detail, according to an exemplary embodiment of the present invention; and

FIG. 4C is a diagram illustrating signals outputted from the apparatus, as illustrated in FIG. 3, for processing a defect, according to an exemplary embodiment of the present invention.

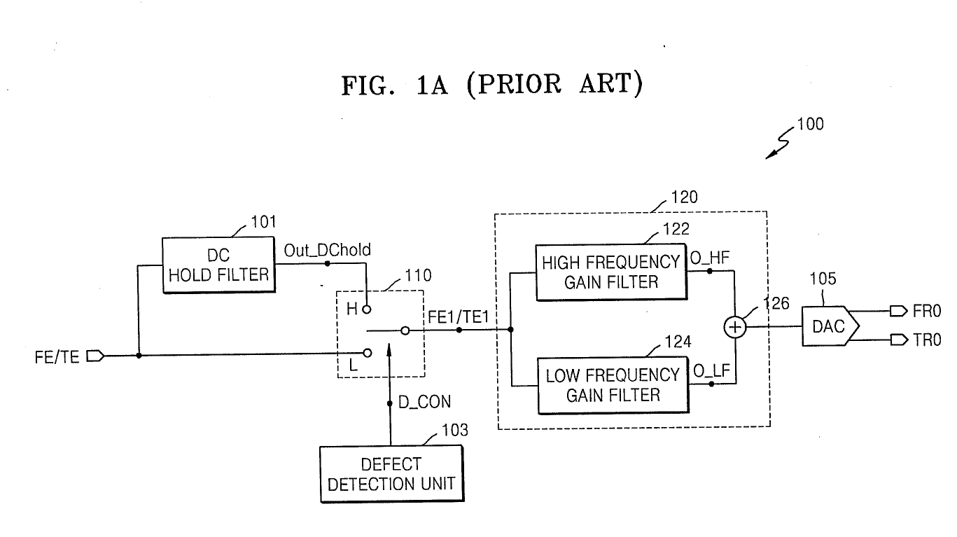

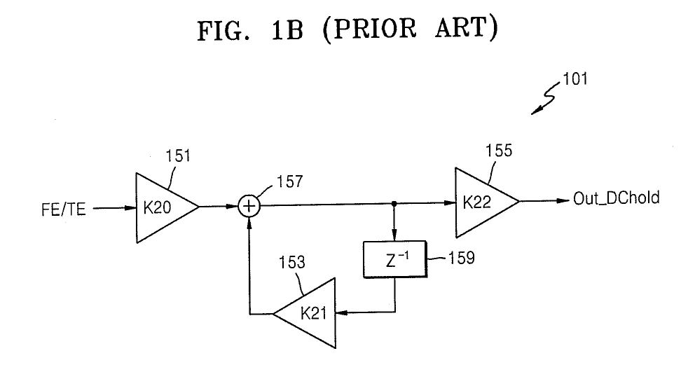

### DETAILED DESCRIPTION OF EXEMPLARY EMBODIMENTS

The attached drawings for illustrating exemplary embodiments of the present invention are referred to in order to gain a sufficient understanding of the present invention, the merits thereof, and the objectives accomplished by the implementation of the present invention.

Hereinafter, the present invention will be described in detail by explaining exemplary embodiments of the present invention with reference to the attached drawings. Like reference numerals in the drawings denote like elements.

FIG. 3 is a diagram illustrating an apparatus for processing a defect, the apparatus included in an optical disc apparatus according to an exemplary embodiment of the present invention.

Referring to FIG. 3, the apparatus 300 includes a defect detection unit 301 and a main filter 310.

The defect detection unit 301 detects a defect present on the surface of a disc from the reflected light beam Sum_mainbeam signal and outputs a reset signal S_RESET. The logic level of the reset signal S_RESET may be logic high or logic low according to the settings of a user.

The main filter 310 receives a focus error (FE) signal or a tracking error (TE) signal as a digital input signal, filters the FE signal or the TE signal in order to output a focus regulation (FRO) signal or a tracking regulation (TRO) signal respectively regulating a focus of a light source or a tracking of a track in the disc.

In an exemplary embodiment, the FE signal or the TE signal generated as an analog signal should be inputted to the main filter 310 as a digital signal. Accordingly, although not illustrated, an analog to digital converter (ADC) is installed at a front terminal (an input terminal) of the main filter 310.

The high-frequency gain filter 312 receives the FE signal or the TE signal and outputs the FE signal or the TE signal after filtering a high-frequency component of the FE or TE signals. In an exemplary embodiment, the high-frequency component is a signal at 500 Hz or higher, and the signal is selected from a frequency band that a user desires to amplify. The high-frequency gain filter 312 only passes signals in the frequency band that the user desires and has the characteristics of a bandpass filter (BPF).

The low-frequency gain filter 314 receives the FE signal or the TE signal and outputs the FE signal or the TE signal after passing a low-frequency component of the FE or TE signals. In an exemplary embodiment, the low-frequency component is a signal at 100 Hz or lower, and the signal is selected from a frequency band that the user desires to amplify.

An adder 316 adds and outputs signals O_HF and O_LF respectively outputted from the high-frequency gain filter 312 and the low-frequency gain filter 314.

A digital to analog converter (DAC) 320 converts a signal outputted from the adder 126 to an analog signal, and outputs a focus regulation (FRO) signal and a tracking regulation (TRO) signal.

In an exemplary embodiment, the reset signal S_RESET resets the signal values of the high frequency component that is passed by the high-frequency gain filter 312 to 0 or a certain offset value. More specifically, the reset signal S_RESET resets the signal values of the high-frequency component that pre-existed in the high-frequency gain filter 312 including the high-frequency component of the FE signal or the TE signal in the high-frequency gain filter 312 to 0 or to a predetermined offset value. Generally, filtering devices in a digital filer can be expressed as Z⁻¹ with values of k*(1/jw). Such filtering devices in the digital filter correspond to capacitors in an analog filter. Accordingly, the signal components in the digital filter correspond to values of the voltages at both ends of the capacitors.

The signal values of the high frequency component are reset to 0 in order to remove the signal values of the high-frequency component inside the high-frequency gain filter 312. Also, the signal values of the high-frequency component are reset to the predetermined offset value in order to adjust the initial values stored in the filtering devices to a uniform value. When the signal values of the high-frequency component are reset to the offset value, a signal can be detected by extracting the offset value during an input and output. For example, when the offset value is 3 V and the output is 5 V, the actual output value is 2 V.

A signal generated due to a defect in the disc has at least hundreds of Hz in terms of frequency. Conventionally, the signal generated due to the defect in the disc has a frequency between 1 Khz to 10 Khz.

Only the signal values in the high-frequency gain filter 312 are reset because a signal component converted due to the defect in the disc is the high-frequency component of the FE signal or the TE signal. Accordingly, when the high-frequency component of the FE signal or the TE signal is converted and inputted to the main filter 310 due to the defect in the disc, the signal components in the high-frequency gain filter 312 are reset to 0000 (zero) and then outputted. Accordingly, an accurate FRO signal or TRO signal can be outputted in spite of the defect in the disc.

The low-frequency component of the FE signal or the TE signal is not related to the presence of the defect in the disc and, thus, does not change. Accordingly, the low-frequency gain filter 314, which outputs the low-frequency component of the FE signal or the TE signal, does not need to be reset.

The adder 316 removes the high frequency component of the FE signal or the TE signal that is undesirably generated due to the defect in the disc, and only outputs the low-frequency component of the FE signal or the TE signal that are to be correctly output.

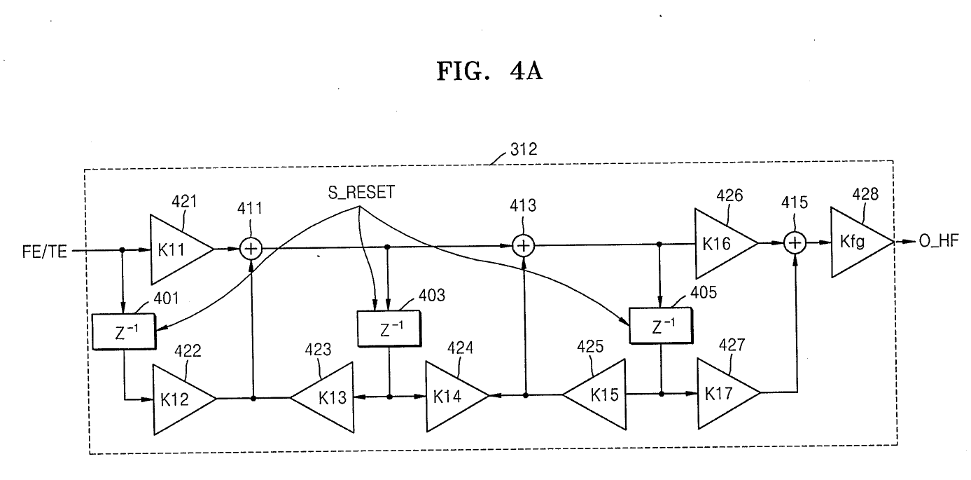

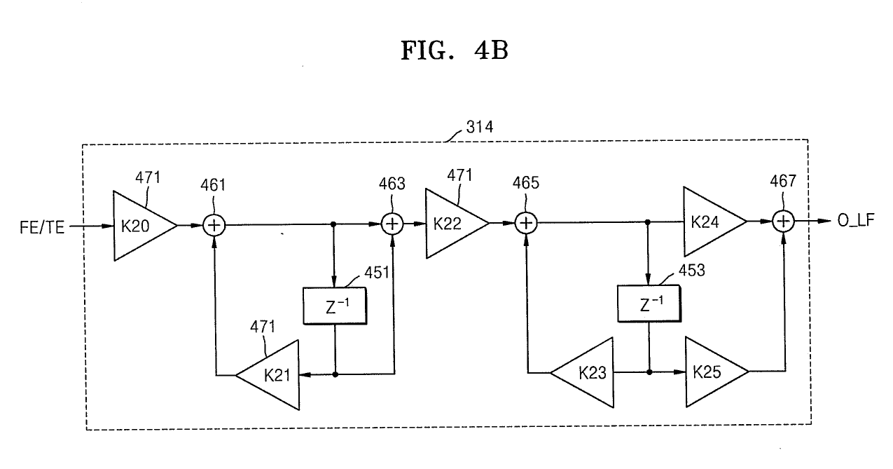

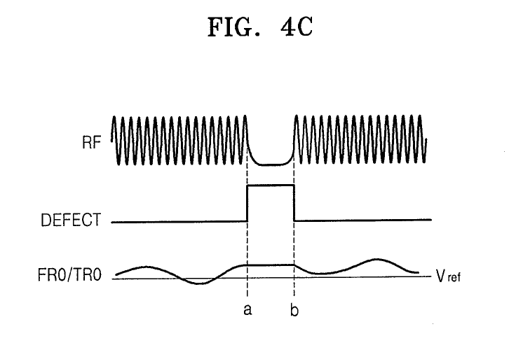

FIG. 4A is a circuit diagram of the high-frequency gain filter 312 illustrated in FIG. 3, according to an exemplary embodiment of the present invention.

The high-frequency gain filter 312 includes a plurality of filtering devices 401, 403, and 405, a plurality of adders 411, 413, and 415, and a plurality of amplifiers 421 through 428.

As described above, the filtering devices (Z⁻¹) 401, 403, and 405 can be expressed as k*(1/jw), and filter signals of a certain frequency. In the exemplary embodiment, a decision on whether to filter a low frequency, a high frequency, or a certain frequency depends on how the filtering devices 401, 403, and 405 are disposed and connected. Also, when the reset signal S_RESET outputted from the defect detection unit 301 of FIG. 3 is applied to the filtering devices 401, 403, and 405, the high-frequency signal components stored in the filtering device 401, 403, and 405 are reset to 0 or a predetermined offset value. As described above, because the high-frequency signal components are all reset to 0 or the predetermined offset value, the output of the high-frequency gain filter 312 can be outputted while the high-frequency signal components are being controlled.

The high-frequency gain filter 312 illustrated in FIG. 4A is constructed as a BPF. Even when the same frequency is bandpass filtered, the constitutions and connections of the filtering devices 401, 403, and 405 may vary based on filter design principles. In other words, the constitutions and connections of the high-frequency gain filter 312 are not limited to what is shown and may vary based on a filter design and specifications.

A response characteristic of the high frequency gain filter 312 of FIG. 4A can be defined by Equation 1 below.

$$H ( Z ) = \frac{K 11 + K 12 \times {Z}^{- 1}}{1 - K 13 \times {Z}^{- 1}} \times \frac{1 + K 14 \times {Z}^{- 1}}{1 - K 15 \times {Z}^{- 1}} \times ( K 16 + K 17 \times {Z}^{- 1} ) \times Kfg \times {2}^{6} \qquad ( 1 )$$

Here, H(Z) denotes the response characteristic of the high-frequency gain filter 312. K11 through K17 respectively denote amplifying rate (amplifying gain) of the amplifiers 421 through 427. Also, Z⁻¹ denotes the filtering devices 401, 403, and 405 in the high-frequency gain filter 312. As described above, Z⁻¹ has the value of k*(1/jw).

In this exemplary embodiment, k is an invariable number determined based on filter design, and j is an imaginary number. Also, w is 2*pi*f, (where pi is an irrational number and f is frequency in Hz). The value of 2⁶ in Equation 1 is for moving a cipher of the response characteristic H(Z). Hence, by including a shift resister (not shown), the desired cipher can be obtained. Accordingly, the value multiplied at the end of Equation 1 for moving the cipher of the response characteristic H(Z) can be changed according to the user.

The obtaining of the response characteristic from the high-frequency gain filter 312 of FIG. 4A is well known to one of ordinary skill in the related filter art and, thus, detailed descriptions thereof will be omitted.

FIG. 4B is a diagram illustrating the low-frequency gain filter 314 illustrated in FIG. 3 in detail, according to an exemplary embodiment of the present invention.

Just as in the high-frequency gain filter 312, the low-frequency gain filter 314 includes a plurality of filtering devices 451 and 453, a plurality of adders 461, 463, 465, and 467, and a plurality of amplifiers 471. As in the high-frequency gain filter 312, a constitution of the low-frequency gain filter 314 can vary based on filter design principles, and is not limited to the one shown.

FIG. 4C is a diagram illustrating signals outputted from the apparatus 300, as illustrated in FIG. 3, for processing a defect, according to an exemplary embodiment of the present invention.

In the apparatus 300 according to an exemplary embodiment of the present invention, the reset signal S_RESET is outputted during the track section a to b in order to remove the high-frequency signal components in the high-frequency gain filter 312 or reset the high-frequency signal components in the high-frequency gain filter 312 to the predetermined offset value. Accordingly, a distortion in the high-frequency component signals affected by the defect in the disc can be prevented and only a low-frequency component signal at the point at which the defect occurs is outputted.

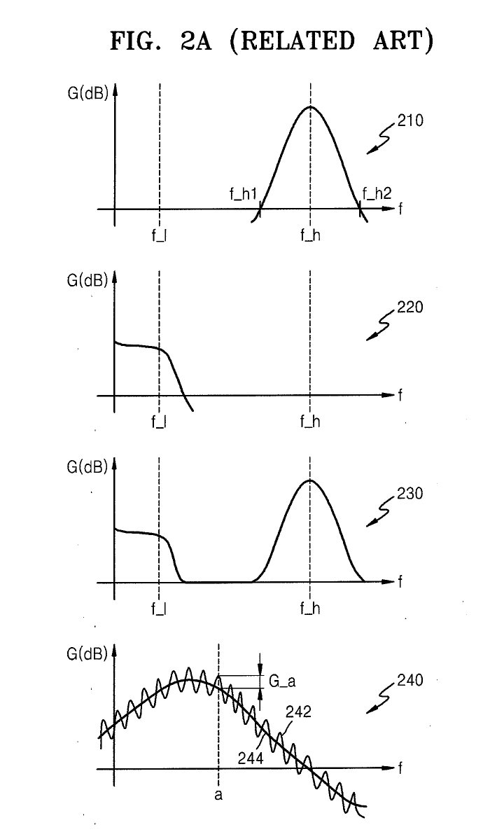

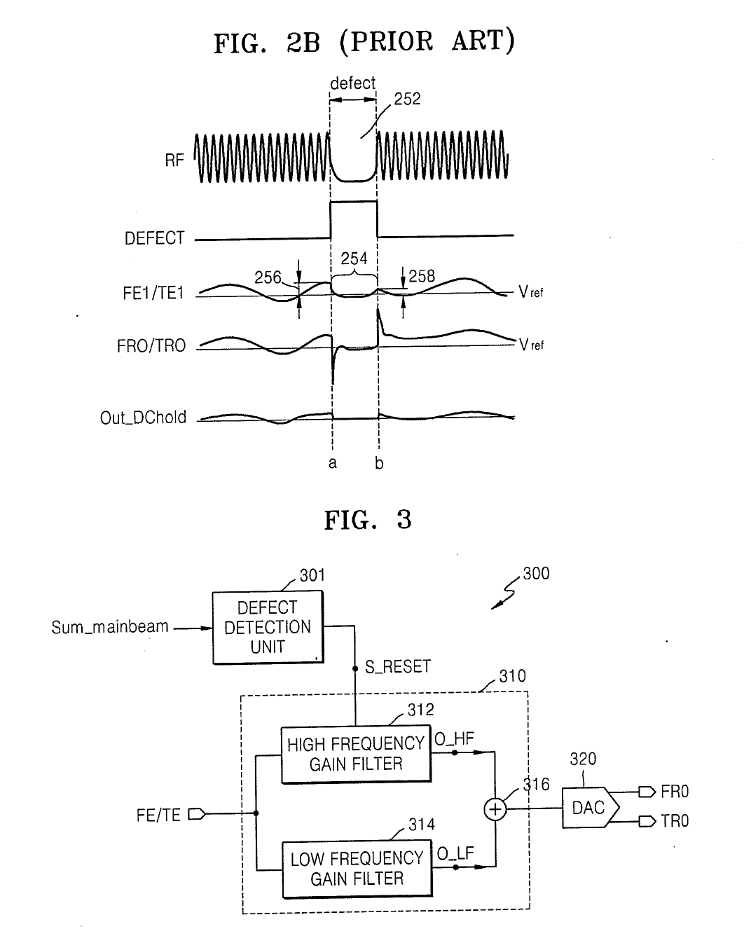

The FE signal or the TE signal is outputted from the main filter 310 after the discontinuous points 256 and 258 illustrated in FIG. 2B are removed. Accordingly, the peaking phenomenon generated in the FRO signal or the TRO signal is removed.

As described above, the apparatus for processing a defect in the optical disc apparatus according to an exemplary embodiment of the present invention resets the signal values of the high-frequency component in the focus/tracking main filter to 0 or to a predetermined offset value in order to remove the peaking phenomenon of the FRO signal or the TRO signal. Moreover, by removing the peaking phenomenon, an accurate servo filter characteristic can be obtained.

Also, the apparatus for processing a defect in the optical disc apparatus does not include a DC hold filter, which is employed in the conventional apparatus for processing a defect and, thus, a constitution of the apparatus for processing a defect is simplified.

While the present invention has been particularly shown and described with reference to exemplary embodiments thereof, it will be understood by one of ordinary skill in the art that various changes in form and details may be made therein without departing from the spirit and scope of the present invention, as defined by the following claims.

What is claimed is:

1. An apparatus for processing a defect, the apparatus comprising:
a main filter;
a defect detection unit that detects a defect in a disc, and when the defect is detected, outputs a reset signal to the main filter; wherein
the main filter receives a focus error signal or a tracking error signal, which are digital signals, and outputs a focus regulation signal or a tracking regulation signal to regulate a focus or a tracking location by filtering the focus error signal or the tracking error signal,
wherein the reset signal resets signal values of a high-frequency component existing in the main filter to 0.

2. The apparatus of claim 1, wherein the main filter resets the signal values of the high-frequency component to 0 when the reset signal is applied thereto, and outputs the focus regulation signal or the tracking regulation signal after removing the high-frequency component of the focus error signal or the tracking error signal.

3. The apparatus of claim 2, wherein the main filter comprises:
a high frequency gain filter that filters the focus error signal or the tracking error signal to have a high-frequency gain and then outputs the filtered focus error signal or the filtered tracking error signal;
a low frequency gain filter that filters the focus error signal or the tracking error signal to have a low-frequency gain and then outputs the filtered focus error signal or the filtered tracking error signal; and
an adder that outputs the focus regulation signal or the tracking regulation signal by adding an output of the high-frequency gain filter and an output of the low-frequency gain filter.

4. The apparatus of claim 3, wherein the high-frequency gain filter operates in response to the reset signal when the defect is detected, and initializes signal values of the high-frequency component existing in the high-frequency gain filter to 0 when the reset signal is applied.

5. The apparatus of claim 2, further comprising a digital to analog converter that receives the focus regulation signal or the tracking regulation signal from the main filter and then outputs the focus regulation signal or the tracking regulation signal after converting the focus regulation signal or the tracking regulation signal to an analog signal.

6. The apparatus of claim 3, wherein the low-frequency gain filter filters the low-frequency component of the focus regulation signal or the tracking regulation signal, and controls the received focus regulation signal or the tracking regulation signal to pass only a low-frequency component of the focus error signal or the tracking error signal.

7. The apparatus of claim 5, further comprising an analog to digital converter that is connected to a front terminal of the main filter and converts the focus error signal and the tracking error signal generated as analog signals to digital signals before outputting the focus error signal and the tracking error signal.

8. An apparatus for processing a defect, the apparatus comprising:
a main filter;
a defect detection unit that detects a presence of a defect in a disc and outputs a reset signal to the main filter when the defect is detected; and
the main filter receives a focus error signal or a tracking error signal, which are digital signals, and outputs a focus regulation signal or a tracking regulation signal to regulate a focus or a tracking location by filtering the focus error signal or the tracking error signal,
wherein the reset signal resets the signal values of a high-frequency component existing in the main filter to a predetermined offset value.

9. The apparatus of claim 8, wherein the predetermined offset value is a value, that offsets the signal values of the high-frequency component existing in the main filter to be fixed to a uniform value and is specified by a user.

10. The apparatus of claim 9, wherein the main filter resets an output value of the high-frequency component existing in the main filter to have the offset value when the reset signal is applied, and outputs the focus error signal or the tracking error signal after removing the high-frequency component of the focus error signal or the tracking error signal, leaving the offset value.

11. The apparatus of claim 9, wherein the main filter comprises:
a high-frequency gain filter that filters the focus error signal or the tracking error signal to have a high-frequency gain and then outputs the filtered focus error signal or the filtered tracking error signal;
a low-frequency gain filter that filters the focus error signal or the tracking error signal to have a low-frequency gain and then outputs the filtered focus error signal or the filtered tracking error signal; and
an adder that outputs the focus regulation signal or the tracking regulation signal by adding an output of the high-frequency gain filter and an output of the low-frequency gain filter.

12. The apparatus of claim 11, wherein the high-frequency gain filter operates in response to the reset signal when the defect is detected and initializes the signal values of the high-frequency component existing in the main filter to the offset value when the reset signal is applied.

13. The apparatus of claim 9, further comprising a digital to analog converter that receives the focus regulation signal or the tracking regulation signal from the main filter and then outputs the focus regulation signal or the tracking regulation signal after converting the focus regulation signal or the tracking regulation signal to an analog signal.

14. The apparatus of claim 9, wherein the low-frequency gain filter filters the low-frequency component of the focus regulation signal or the tracking regulation signal and controls the received focus regulation signal or the tracking regulation signal to to pass only a low-frequency component of the focus error signal or the tracking error signal.

15. The apparatus of claim 13, further comprising an analog to digital converter that is connected to a front terminal of the main filter and converts the focus error signal and the tracking error signal generated as analog signals to digital signals before outputting the focus error signal and the tracking error signal.
